(19) United States
(12) Patent Application Publication
(10) Pub. No.: US 2014/0152800 A1
(43) Pub. Date: Jun. 5, 2014

(54) IMAGE QUALITY OPTIMIZATION OF BIOLOGICAL IMAGING

(71) Applicants: Pavel A. Fomitchov, New York, NY (US); Witold Bula, St Catharines (CA)

(72) Inventors: Pavel A. Fomitchov, New York, NY (US); Witold Bula, St Catharines (CA)

(73) Assignee: GE Healthcare Bio-Sciences Corp., Piscataway, NJ (US)

(21) Appl. No.: 14/129,699

(22) PCT Filed: Jun. 27, 2012
(86) PCT No.: PCT/SE2012/050720

§ 371 Date: Dec. 27, 2013

Related U.S. Application Data
(60) Provisional application No. 61/503,072, filed on Jun. 30, 2011.

(51) Int. Cl. G01N 21/64; G02B 21/36

(52) U.S. Cl. CPC G01N 21/6458; G02B 21/365
USPC 348/79

(57) ABSTRACT

Microscopy system for biological imaging, comprising an image quality optimizer for optimizing image quality of an image of a biological sample, allowing a user to select an optimization mode from a list of functionally defined optimization modes, and wherein the system is arranged to automatically set one or more image acquisition parameters to achieve optimal imaging for the selected optimization mode based on at least one image quality parameter derived from one or more Biological Reference Objects (BRO) in the image of the biological sample selected by the user or automatically by the system.

### FIELD OF THE INVENTION

The present invention relates to a microscopy system for biological imaging, and in particular a microscopy system, comprising a system for optimizing image quality of an image of a biological sample.

### BACKGROUND OF THE INVENTION

Generally, when researching tiny regions of interest on a sample, researchers often employ a fluorescence microscope to observe the sample. The microscope may be a conventional wide-field, structured light or confocal microscope. The optical configuration of such a microscope typically includes a light source, illumination optics, beam deflector, objective lens, sample holder, filter unit, imaging optics, a detector and a system control unit. Light emitted from the light source illuminates the region of interest on the sample after passing through the illumination optics and the objective lens. Microscope objective forms a magnified image of the object that can be observed via eyepiece, or in case of a digital microscope, the magnified image is captured by the detector and sent to a computer for live observation, data storage, and further analysis.

In wide-field microscopes, the target is imaged using a conventional wide-field strategy as in any standard microscope, and collecting the fluorescence emission. Generally, the fluorescent-stained or labeled sample is illuminated with excitation light of the appropriate wavelength(s) and the emission light is used to obtain the image; optical filters and/or dichroic mirrors are used to separate the excitation and emission light.

Confocal microscopes utilize specialized optical systems for imaging. In the simplest system, a laser operating at the excitation wavelength of the relevant fluorophore is focused to a point on the sample; simultaneously, the fluorescent emission from this illumination point is imaged onto a small-area detector. Any light emitted from all other areas of the sample is rejected by a small pinhole located in front to the detector which transmits on that light which originates from the illumination spot. The excitation spot and detector are scanned across the sample in a raster pattern to form a complete image. There are a variety of strategies to improve and optimize speed and throughput which are well known to those skilled in this area of art.

Line-confocal microscopes is a modification of the confocal microscope, wherein the fluorescence excitation source is a laser beam; however, the beam is focused onto a narrow line on the sample, rather than a single point. The fluorescence emission is then imaged on the optical detector through the slit which acts as the spatial filter. Light emitted from any other areas of the sample remains out-of-focus and as a result is blocked by the slit. To form a two-dimensional image the line is scanned across the sample while simultaneously reading the line camera. This system can be expanded to use several lasers and several cameras simultaneously by using an appropriate optical arrangement.

One type of line confocal microscope is disclosed in U.S. Pat. No. 7,335,898, which is incorporated by reference, wherein the optical detector is a 2 dimensional sensor element operated in a rolling line shutter mode whereby the mechanical slit can be omitted and the overall system design may be simplified.

As the above types of microscope systems are further developed and new technologies are invented, the users of such systems get more and more possibilities to get better images by selecting the most appropriate values for a large number of image acquisition parameters. As most users of microscope systems for biological imaging rather are biologists and not experts in the field of advanced optics, there is a need for tools that assist them in optimizing the image acquisition parameters in order to get as much information from the images as possible.

### SUMMARY OF THE INVENTION

The object of the invention is to provide a new microscopy system for biological imaging, which overcomes one or more drawbacks of the prior art. This is achieved by the microscopy system for biological imaging as defined in the independent claims.

One advantage with such a microscopy system for biological imaging is that it is arranged to provide optimization of the image quality for specific biological imaging situations, either through user assistance or through fully automated procedures, and wherein the image quality parameters that are optimized are directly related to the biological sample being imaged.

According to one embodiment, there is provided a microscopy system for biological imaging, comprising an image quality optimizer for optimizing image quality of an image of a biological sample, allowing a user to select an optimization mode from a list of functionally defined optimization modes, and wherein the system is arranged to automatically set one or more image acquisition parameters to achieve optimal imaging for the selected optimization mode based on at least one image quality parameter derived from one or more Biological Reference Objects (BRO) in the image of the biological sample selected by the user or automatically by the system.

The functionally defined optimization modes may comprise one or more of:
Best image quality;
Fast acquisition;
Low bleaching; and
3D imaging.

The image quality parameter may be one or more of:
the Relative Signal between the BRO(s) and the background;
the Signal to Background Ratio (SBR) between the Relative Signal and the background; and
the Signal to Noise Ratio between the Relative Signal and the Background Noise.

According to one embodiment, the microscopy system comprises an image quality monitoring system for monitoring image quality of an image of a biological sample comprising:
a biological object selection means arranged to let a user of the system to select one or more Biological Reference Objects (BRO) in the image of the biological sample;
an image quality evaluation means arranged to compare the signal level of image pixels of the one or more BROs with an image background signal level to calculate one or more image quality parameters for the image of the biological sample; and
wherein the one or more image quality parameters are used by the quality optimizer for optimizing the image quality.

The microscopy system may further comprise a background selection means arranged to let a user of the system to select one or more Background Reference Regions (BRR) in the displayed image of the biological sample and wherein the system is arranged to use the signal level of image pixels of the one or more BRRs as the image background signal level for calculating the one or more image quality parameters.

The microscopy system may further be arranged to automatically select one or more Background Reference Regions (BRR) in the displayed image of the biological sample, and arranged to use the signal level of image pixels of the one or more BRRs as the image background signal level for calculating the one or more image quality parameters. The microscopy system may further be arranged to select BRRs by locating the image pixels with the lowest signal level.

The biological object selection means may further be arranged to let the user select the one or more BRO's by marking one or more Regions of Interest (ROI) in the displayed image of the biological sample. The microscopy system may further be arranged to automatically detect and select additional BROs and/or BRRs in the image or in subsequent images based on characterizing features of the BRO(s)/BRR(s) selected by the user, and use them for calculation of the image quality parameter(s). The microscopy system may further be arranged to automatically re-position BROs and/or BRRs in the image or in subsequent images based on lateral shift of the sample.

According to one embodiment, the microscopy system may be a fluorescence microscope comprising an excitation light source, and a detector arranged to register fluorescence emitted from the biological sample. The microscopy system may further be a confocal microscope, or a line confocal microscope with a variable confocal aperture.

According to one embodiment, there is provided a method for optimizing image quality of an image of a biological sample from a microscopy system for biological imaging, selecting an optimization mode from a list of functionally defined optimization modes, deriving at least one image quality parameter from one or more Biological Reference Objects (BRO) in the image of the biological sample selected by a user or automatically, and setting one or more image acquisition parameters to achieve optimal imaging for the selected optimization mode based on an optimization model.

Further scope of applicability of the present invention will become apparent from the detailed description given hereinafter. However, it should be understood that the detailed description and specific examples while indicating preferred embodiments of the invention are given by way of illustration only. Various changes and modifications within the spirit and scope of the invention will become apparent to those skilled in the art from the detailed description below.

### BRIEF DESCRIPTION OF THE DRAWINGS

FIG. 1 is a schematic block diagram of a microscope system in accordance with the invention.

FIG. 2 is a schematic illustration of key parameters for calculating image quality parameters

FIG. 3 shows an example of an image of a biological sample

FIG. 4 is an example of a graphical representation of image quality parameters.

FIGS. 5-14 schematically show examples of image quality optimization methodology in accordance with the invention.

### DETAILED DESCRIPTION OF THE INVENTION

Embodiments of the invention are described with reference to the drawings, where like components are identified with the same numerals. The descriptions of the embodiments are exemplary and are not intended to limit the scope of the invention.

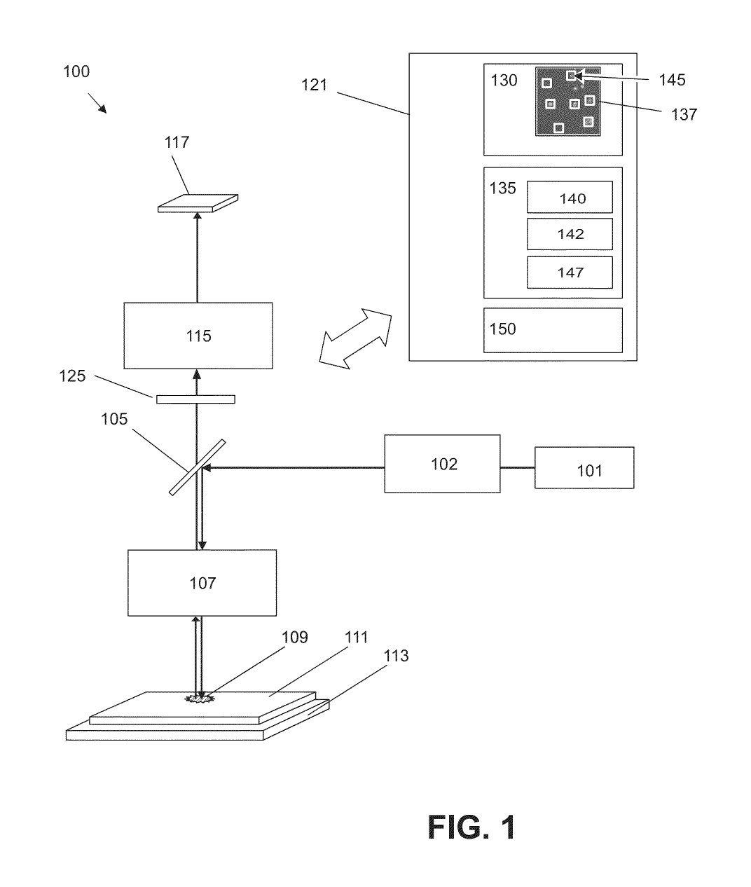

FIG. 1 illustrates a block diagram of the essential components of a typical digital fluorescence microscope system. This automated digital microscope system 100 includes the following components: a light source 101, illumination optics 102, beam folding optics 105 (optional), objective lens 107, a sample holder 111 for holding a sample 109, a stage 113, a imaging optics 115, an optical detector 117, and an system control unit 121. The system may contain other components as would ordinarily be found in confocal and wide field microscopes. The following sections describe these and other components in more detail. For a number of the components there are multiple potential embodiments. In general the preferred embodiment depends upon the target application.

Light source 101 may be a lamp, a laser, a plurality of lasers, a light emitting diode (LED), a plurality of LEDs or any type of light source known to those of ordinary skill in the art that generates a light beam. Light beam is delivered by: the light source 101, illumination optics 102, beam-folding optics 105 and objective lens 107 to illuminate a sample 109. Sample 109 may be live biological materials/organisms, biological cells, non-biological samples, or the like. Illumination optics 102 may comprise any optical element or combination of elements that is capable of providing the desired illumination of the sample 109. According to one embodiment, the microscope system is a point scan confocal microscope. According to one embodiment, the microscope system is a line scan confocal microscope, wherein the illumination optics comprises a line forming element such as a Powell lens or the like. Beam-folding optics 105 is a typical scanning mirror or a dichroic mirror depending on the microscope type. The emission light emitted from the sample 109 is collected by objective lens 107, and then an image of the sample 109 is formed by the imaging optics 115 on the optical detector 117. The optical detector 117 may be a charged coupled device (CCD), a complementary metal-oxide semiconductor (CMOS) image detector or any 2-D array optical detector utilized by those of ordinary skill in the art. According to one embodiment, the microscope system may be a point scan confocal microscope comprising a point detector such as a PMT or the like. Optical detector 117 is optionally, electrically or wirelessly, connected by a communications link to the system control unit 121. Also, there may be two, three or more optical detectors 117 utilized in place of optical detector 117. The sample holder 111 is arranged to hold one or more samples 109, may be a typical microtiter plate, a microscope slide, a chip, plate of glass, Petri dish, flask, or any type of sample holder.

The microscope system 100 may be referred to as an image transmitting device, imaging device or imaging system that is capable of capturing an image, by utilizing the optical detector 117, of the sample 109 or any type of object that is placed on the object stage 113. Also, the microscope system 100 may also be, for example, the IN Cell Analyzer 2000 or 6000 manufactured by GE Healthcare located in Piscataway, N.J. Microscope system 100 may be a typical confocal microscope, fluorescent microscope, epi-fluorescent microscope, phase contrast microscope, differential interference contrast microscope, or any type of microscope known to those of ordinary skill in the art. In another embodiment, the microscope system 100 may be a typical high throughput and high content sub cellular imaging analysis device that is able to rapidly detect, analyze and provide images of biological organisms or the like. Also, the microscope system 100 may be an automated cellular and sub-cellular imaging system.

The system control unit 121 may be referred to as an image receiving device or image detection device. The system control unit 121 may be a dedicated control system physically integrated with the microscope system, an external unit connected to the microscope system through a communication link, or any combination thereof with some functionality integrated into the system and some external. The system control unit 121 acts as a typical computer, which is capable of receiving an image of the sample 109 from the optical detector 117, then the system control unit 121 is able to display, save or process the image by utilizing an image processing software program, algorithm or equation.

System control unit 121 includes the typical components associated with a conventional computer, laptop, netbook or a tablet. The system control unit 121 is connected by the communication link to the microscopy system for reading data e.g. from the optical detector 117, and controlling components of the microscope system to perform operations of image acquisition etc. The system control unit 121 comprises a graphical user interface (GUI) 130 capable of displaying images of the sample 109 and input means for user interaction, such as a keyboard and pointing devices or the like.

According to one embodiment, the present microscopy system for biological imaging comprises an image quality (IQ) monitoring system 135 for monitoring image quality of an image 137 of a biological sample. The IQ monitoring system 135 is arranged to facilitate for a user to judge the relative quality of the image by presenting image quality parameters that are directly related to the specific biological objects of interest and which parameters are easily interpreted and indicative of how to improve the image quality. In order to achieve this, the IQ monitoring system 135 comprises a biological object selection means 140 arranged to let a user of the system to select one or more Biological Reference Objects (BRO) 145 in the image 137 of the biological sample, and image quality evaluation means 142 arranged to compare the signal level of image pixels of the one or more BROs 145 with an image background signal level to calculate one or more image quality parameters for the image 137 of the biological sample 109. These image quality parameters are then presented the user as an indication of the image quality specific for the BRO(s) in the image 137 of the biological sample.

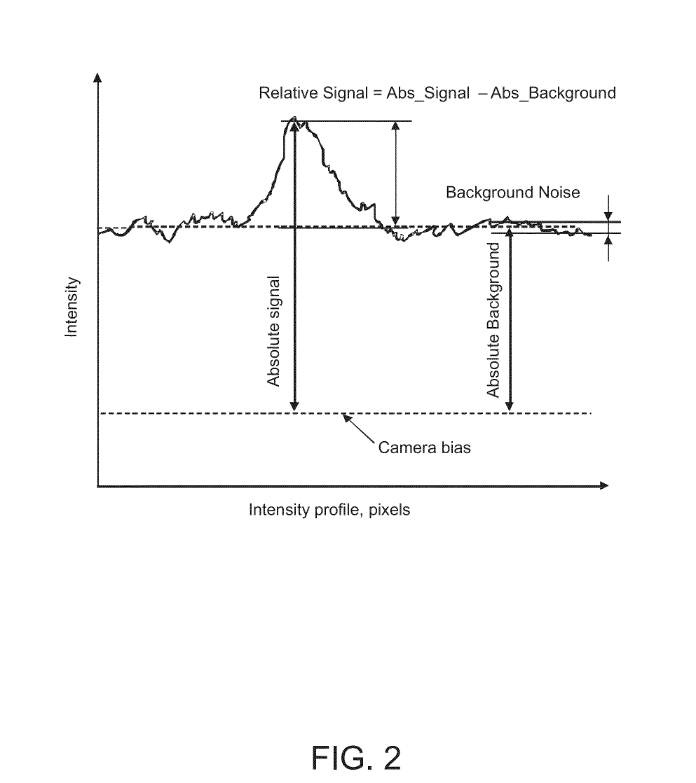

As is already mentioned, the image quality parameters presented to the user should be directly related to the specific biological objects of interest and easily interpreted and indicative of how to improve the image quality by changing the imaging settings for the microscopy system 100. In order to provide image quality parameters according to the present invention the following parameters as illustrated in FIG. 2 may be assessed and used to calculate parameters that are suitable as image quality parameters:
Image offset is e.g. a fixed offset value that is applied to all pixels in the image by image acquisition software.
Dark noise level is a measure representative of the intensity offset for all pixels in the image resulting from accumulation of dark current, read-out noise and other noises in the optical detector 117.
Camera bias is a measure representative of the intensity of a dark image that is defined by Image offset and Dark noise level for a given exposure time. Camera bias may e.g. be measured before start of image acquisition and its value is stored for further image analysis.
Object pixels are pixels within each BRO that are used to calculate object intensity.
Background pixels are pixels within each Background ROI that are used to calculate background intensity and noise.
BRO Absolute Signal is a measure representative of the intensity of Object pixels for a given object ROI minus Camera bias.
ROI Absolute Background is a measure representative of the intensity of Background pixels for a given background ROI minus Camera bias.
ROI Background Noise is a measure representative of the noise of all “background” pixels for a given background ROI such as a standard deviation.
Absolute Signal is a measure representative of the intensity of all BRO Absolute Signals such as the mean intensity.
Absolute Background is a measure representative of the intensity of all ROI Absolute Backgrounds, such as the mean intensity.
Image Noise is a measure representative of the value of all ROI Background Noise values (it may e.g. be the mean value of all standard deviation for Background areas).

According to one embodiment, the image quality parameter(s) calculated on basis of the above parameters and presented to the user is one or more of:
the Relative Signal between the BRO(s) and the background,
the Signal to Background Ratio (SBR) between the Relative Signal and the background, and
the Signal to Noise Ratio (SNR) between the Relative Signal and the Background Noise.

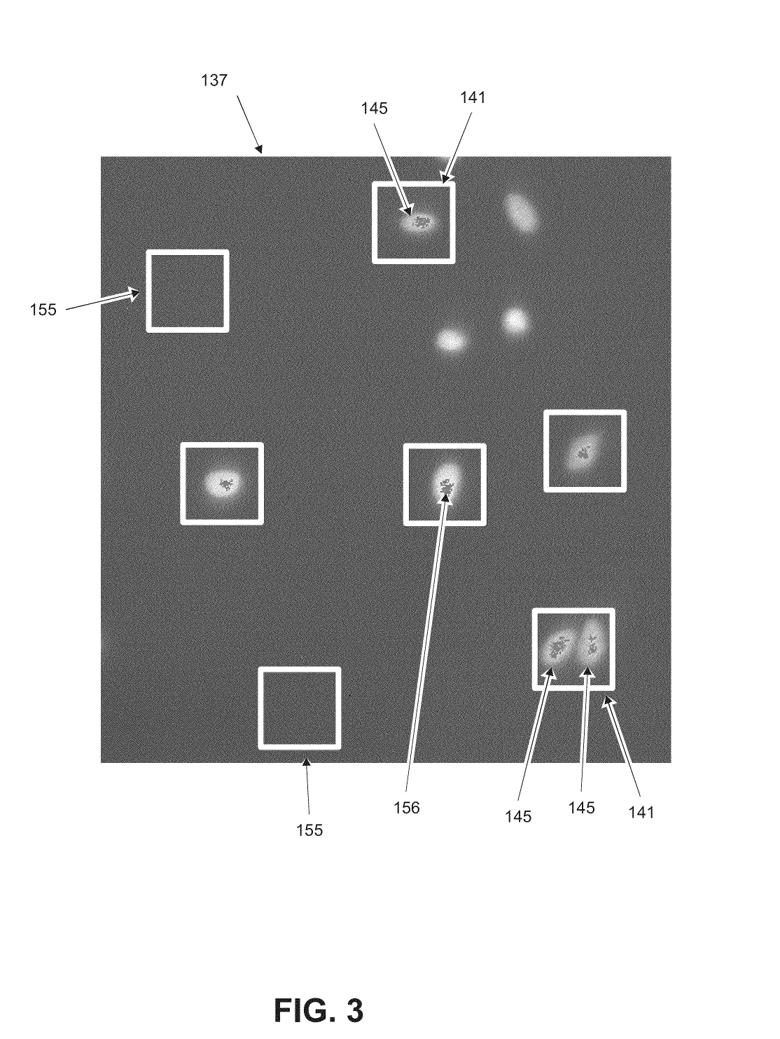

According to one embodiment, the biological object selection means 140 is integrated and implemented with the GUI 130 of the system control unit 121 such that a user can graphically mark and select BRO(s) in the GUI environment, e.g by using a pointer tool, rectangular, oval or arbitrary shape area selection tools or the like. The biological object selection means 140 may be implemented in many ways, but it is important that it is user friendly and intuitive. According to one embodiment, the biological object selection means 140 is arranged to let the user select the one or more BRO's by marking a Region of Interest (ROI) 141 in the displayed image of the biological sample. The IQ monitoring system 135 may be arranged to treat the whole ROI 141 as a BRO, but it may be arranged to automatically identify individual BROs 145 within the borders of the region of interest, e.g. by identifying pixels with high signal level. In FIG. 3, the lower right ROI 141 is shown containing two BROs 145, which may be automatically identified by the IQ monitoring system 135, e.g. by segmentation based on recorded intensity etc.

According to one embodiment, the biological object selection means 140 comprises one or more of the following:
Rectangular selection tool, allowing the user to select rectangular ROI on the image. User is able to adjust size, aspect ratio, angle (rotation) and XY position of each ROI to be selected.
Oval selection tool, allowing the user to select circular or oval ROI on the image. User is able to adjust size, aspect ratio, angle and XY position of each ROI to be selected.
Arrow selection tool, arranged to automatically segment an object based on its local background intensity.

According to one embodiment, the arrow selection tool is a one-step tool where the user simply use the arrow pointer to select a location within a BRO whereby the tool automatically select a background level and segments the BRO. Alternatively, the arrow selection tool is a two-step tool wherein, the user first is guided to use the arrow pointer to select a location outside the BRO indicative of the background level around the BRO, and thereafter to select a location inside the BRO whereby the tool is arranged to automatically segment the BRO using the background level indicated by the user.

According to one embodiment, the image quality evaluation means 142 is arranged to count pixels with intensities within defined range of the BRO as Object pixels. Default object intensity values may be Max=100%, Min=90% of brightest pixel within BRO. These values may be user configurable to allow the user to set appropriate values for each specific imaging situation.

FIG. 3 shows an example of an image of a biological sample wherein five BROs 141 have been selected using the Rectangular selection tool of the biological object selection means 140. As is shown in FIG. 3, the selected ROIs are clearly and intuitively displayed by the GUI. Moreover, Object pixels 156 identified according to above are marked pixel by pixel in the image.

According to one embodiment, the IQ monitoring system 135 comprises a background selection means 147 arranged to let a user of the system to select one or more Background Reference Regions (BRR) 155 in the displayed image of the biological sample and wherein the system is arranged to use the signal level of image pixels of the one or more BRRs as the image background signal level for calculating the one or more image quality parameters. Alternatively the IQ monitoring system 135 is arranged to automatically select one or more Background Reference Regions (BRR) 155 in the displayed image of the biological sample, e.g. by selecting BRRs by locating the image pixels with the lowest signal level. The background selection means 147 is preferably implemented in a similar fashion as the biological object selection means 140 and is not described in more details herein. In the image disclosed in FIG. 3 two BRRs 155 are indicated. Alternatively, the background reference regions may be selected automatically by a suitable algorithm capable of identifying the image pixels with the lowest intensity values or the like e.g. selecting the bottom % of dim pixels from whole FOV.

A user may adjust a position of a sample when using BRO and BRR selection tools. One embodiment will adjust position of both BRO and BRR on the image to compensate lateral sample shift produced by microscope XY stage.

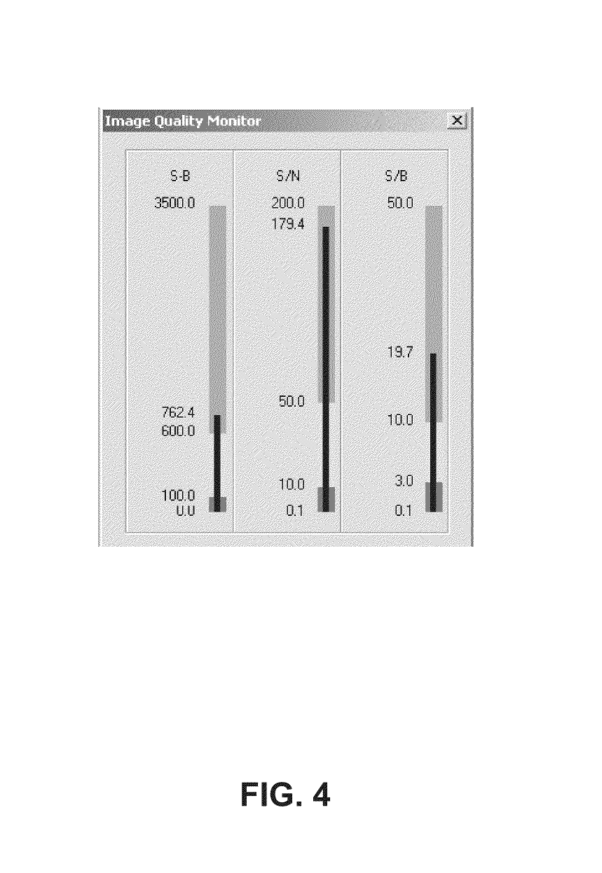

In order to further support the user of the microscopy system 100, the calculated image quality parameter(s) may be presented in relation to reference values indicating the potential of improving the image quality in a comprehensive way, such as in a staple diagram or the like as is schematically shown in FIG. 4. According to one embodiment, said reference values are predetermined with respect to a specific BRO class, wherein the system is arranged to let the user select the appropriate BRO class from a range of different BRO classes. The BRO classes may e.g. be based on historical image quality data for a specific assay setup, biological sample type or the like and comprise relative information about image quality parameters that may be expected for said specific BRO class, with respect to one or more measured quality parameter.

According to one embodiment visual reference points for the measured IQ parameters may be implemented, e.g. as is shown in FIG. 4 by: graphical bars for Signal, SNR, and SBR displaying “best”, “acceptable”, and “low” ranges for each parameter. The “best”, “acceptable”, and “low” ranges on a bar may be color-coded. Default settings are “Green”, “Yellow”, and “Red” respectively. The “best”, “acceptable”, and “low” ranges for each parameter may further be user-configurable. As mentioned, the configuration of “best”, “acceptable”, and “low” ranges for each parameter may be based on user selected target types. Each target may be a user-defined type of biological sample such as “DAPI stained nuclei”, “FYVE assay FITC stain”, “Zfish GFP heart”, etc. . . . .

Selection of targets may e.g. be provided from a drop-down menu that lists currently defined targets.

In certain applications the IQ Monitor display may have a Default target setting. For a Default target setting IQ monitor ranges may be pre-configured (e.g. see FIG. 4). The default Signal-to-Noise Ratio ranges may be 1-10 for “Low”, 10-100 for “Acceptable” and >100 for “Best” or similar.

According yet another embodiment the system is arranged to automatically detect and select additional BROs and/or BRRs in the image or in subsequent images based on characterizing features of the BRO(s)/BRR(s) selected by the user, and use them for calculation of the image quality parameter(s). By utilizing the system's capacity to automatically identify additional BROs and BRRs based on its image analysis capabilities, statistically better values for the image quality parameter(s) can be achieved. The automatic detection of additional BROs/BRRs in subsequent images enables the user e.g. to register the image quality parameter(s) during an automated screening assay of similar samples to ensure that image conditions and quality is consistent throughout the assay.

Image Optimizer

In one embodiment, in addition to give the user feedback on the image quality, the image quality parameter(s) may be used to automatically or using a user assisted scheme optimize the image quality by using the IQ parameters as input parameters for an image quality optimizer 150. According to one embodiment, the microscopy system for biological imaging, comprises an image quality optimizer 150 for optimizing image quality of an image of a biological sample, allowing a user to select an optimization mode from a list of functionally defined optimization modes, and wherein the system is arranged to automatically set one or more image acquisition parameters to achieve optimal imaging for the selected optimization mode based on at least one image quality parameter derived from one or more Biological Reference Objects (BRO) in the image of the biological sample selected by the user or automatically by the system.

According to one embodiment, the functionally defined optimization modes comprises one or more of:

Best image quality,
Fast acquisition/best throughput,
Low bleaching, and
3D imaging.

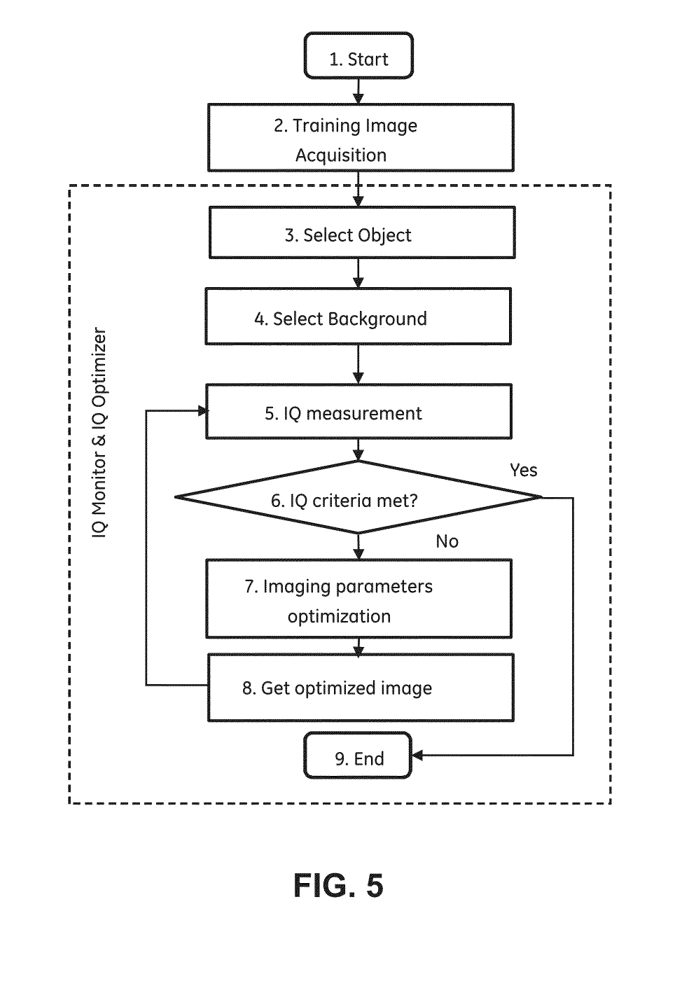

FIG. 5 shows a schematic flow chart of one embodiment of a method of optimizing Image Quality comprising the steps:

### 1. Start

Sample is loaded to imager

### 2. Training Image Acquisition

Instrument may be in “Manual” or in a “IQ Wizard” mode providing wizard type guidance to the user relating to the steps to be performed
Field Of View (FOV) position and focal plane position are selected for imaging the sample in a representative way with respect to the assay to be run on the instrument using the IQ optimizer functionality.

Image acquisition parameters are selected using GUI or from a list of saved predetermined settings, such as the functionally defined optimization modes ad disclosed above and/or assay specific settings such as “Nucleus for monolayer cells”, “Dim GFP sample” or the like, in a new tool bar or menu. Image acquisition parameters may be magnification, exposure time, illumination channel and power, detector modality and imaging mode (e.g. confocal mode in a confocal system) or any other parameter that influences the image quality

### 3. Select Object

Using the biological object selection means 140 to provide a BRO for providing image quality parameters in accordance with the IQ monitor embodiment discussed in detail above.

### 4. Select Background (Optional—May be Automatic)

In this step Image parameters characterizing image noise and background level are estimated in accordance with the IQ monitor embodiment discussed in detail above.

### 5. IQ Measurement

This step involves determination of parameters indicative of image quality e.g. in accordance with the IQ monitor embodiment discussed in detail above. such as:
   SNR
   SBR
   Saturation—Yes/No
According to one embodiment, IQ parameters may be rated based on one or more thresholds, to provide relative indications of image quality, e.g. Low, Med, High.

### 6. IQ Criteria Met?

This step involves determination if the present image quality meet one or more predetermined criteria for image quality in accordance with the functionally defined optimization modes and/or assay specific settings. This determination may be performed either by the user or by automatic decision making algorithm.
According to one embodiment, the determination involves an automatic decision making, and the system may e.g. be arranged to perform a predetermined number of optimization iterations.

### 7. Imaging Parameters Optimization

This step involves determination of updated settings for at least one of the image acquisition parameters, e.g by calculating new settings using one or more optimization models to improve IQ parameters. Such optimization models are highly dependent on the type of imaging system being used, and they may be developed based on analytical parameters as well as empirically and statistically derived parameters.
In a manual mode Predicted IQ parameters may be displayed for suggested changes
New Image Acquisition Settings are sent to the imager

### 8. Get Optimized Image for Evaluation in Steps 5-6

Optimized image is acquired using the updated settings

### 9. End

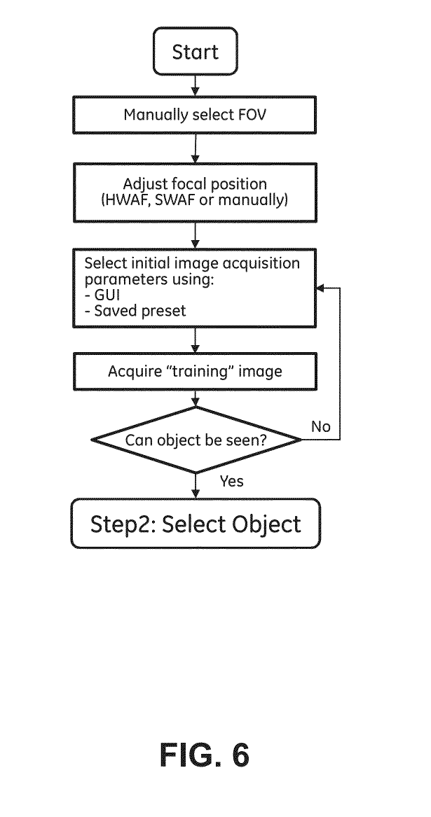

Following a determination in step 6 that the predetermined criteria for image quality is met, an image with optimized image quality is achieved, and the image can be saved and analyzed in subsequent analysis steps or the like. Moreover, the Final image acquisition parameters resulting in optimized image quality may be saved as a preset parameters to be used in subsequent image acquisition of similar samples. The final image acquisition parameters may be saved as a part of protocol.
   In the following, specific of the steps of the IQ optimization method of FIG. 5 will be presented in greater detail in FIGS. 6 to 9 with reference to a confocal microscope system, such as IN Cell Analyzer 6000 manufactured by GE Healthcare located in Piscataway, N.J., but the general principles are applicable to other types of confocal microscopes. Basic principles of such a system are disclosed in U.S. Pat. No. 7,335,898.

FIG. 6 schematically discloses the step of Training Image Acquisition in more detail wherein:

Trainings image may be acquired in:
Manual mode
IQ Wizard mode that will guide user through all steps of IQ optimization process Image acquisition parameters such as exposure time, laser channel/wavelength, laser power, Hardware Autofocus (HWAF) settings, Software Autofocus (SWAF) settings, CMOS detector modality, gain and confocal mode may be selected by user:
directly using GUI;
From saved Presets that are accessible via Imaging Presets toolbar, menu or by other suitable means

Parameters that can saved as Preset parameters may be:
User-defined preset name
Exposure time
Laser channel/wavelength
Laser power
CMOS detector gain
Camera binning factor, i.e. 1×1, 2×2, etc. . . . .
Confocal mode (for IN Cell 6000 e.g. Line scanning mode and Line confocal mode, and width of confocal aperture)
Objective type and magnification
Emission filter
In order to further assist the user in selecting imaging Preset parameters using a Toolbar or menu, the number of imaging Presets selections available for a user to select from may be limited depending on specific instrument settings such as only presets relevant to current laser wavelength and objective may be shown
The user may further be able to delete, save and overwrite presets

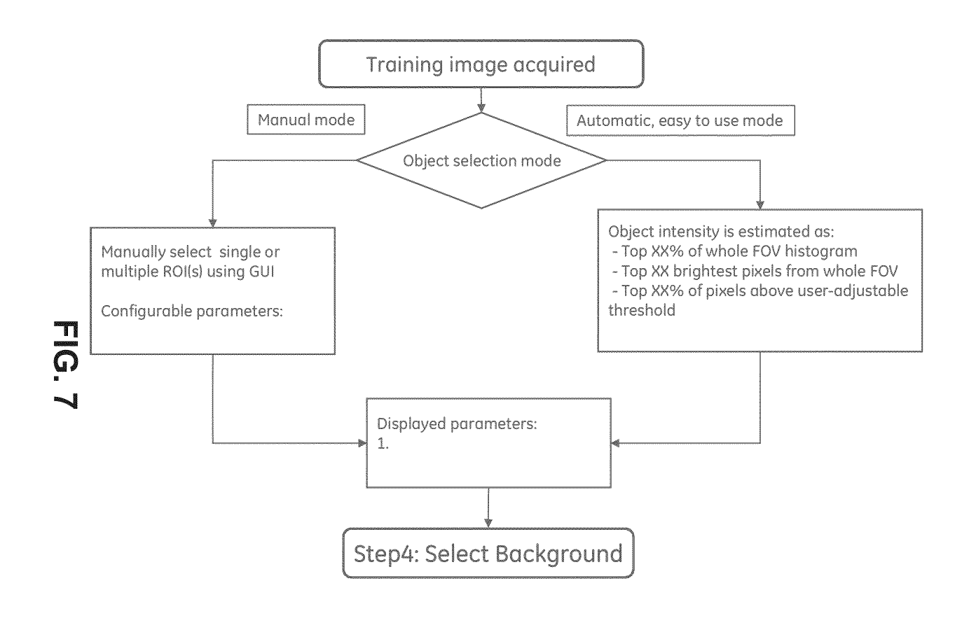

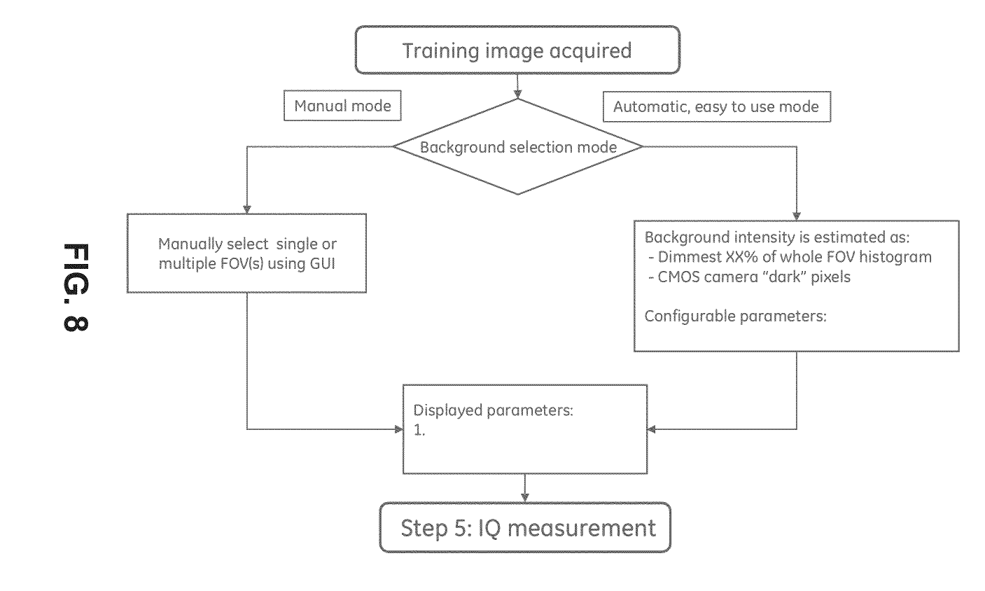

FIGS. 7 and 8 schematically disclose the steps of Select Object and Select Background in more detail, respectively. The steps of IQ measurements is disclosed in detail above with reference to FIGS. 1-4 and the basic concepts are

Goals:
Select and quantify key IQ parameters that drive selection of image acquisition parameters
Simplify workflow of imaging optimization
Minimize human errors by automation

Key IQ parameters that may be optimized for may be:
the Relative Signal between the BRO(s) and the background,
the Signal to Background Ratio (SBR) between the Relative Signal and the background, and
the Signal to Noise Ratio (SNR) between the Relative Signal and the Background Noise.

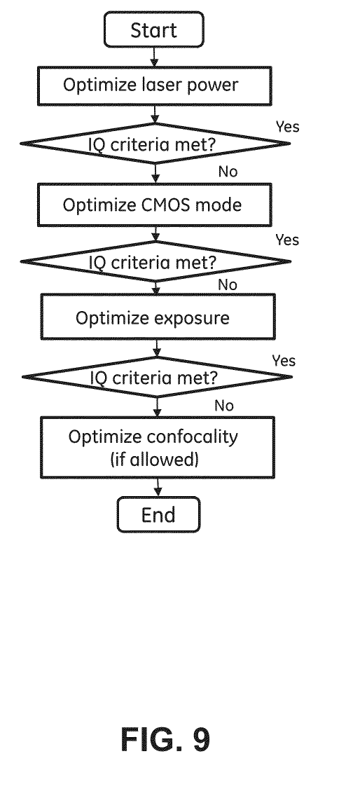

FIG. 9 schematically discloses the step of Imaging parameters optimization in more detail wherein:

IQ parameters may be optimized for:
Best throughput
Best image quality
Low bleaching
3D sectioning

As mentioned, calculation of new settings for optimization of image quality may be based on an optimization model. According to one embodiment relating to optimization of a confocal microscope as presented above, the optimization model is based on a range of Model Assumptions which as mentioned previously depends on the system and the specific implementation. Examples of Model Assumptions in this case are:
Signal level is directly proportional to relative laser power
Signal level is directly proportional to relative exposure time increase
Signal level is directly proportional to camera gain Signal level is increased proportionally camera or image binning factor
Signal level AND background level are reduced with reduction of confocal aperture width

Said optimization model further comprise one or more decision making factors, such as:
Laser power is a preferred parameter to adjust since its increase helps to achieve highest throughput.
Lower camera gain may be used as a preferred since it allows acquisition of images with best possible SNR if a sample is bight. Higher camera gain should be used unless sample is very dim and Absolute Signal cannot reach Best range at full laser power and max exposure.
Non-confocal Open Aperture mode is a preferred mode. Line confocal mode shall be used only if SBR is <0.3—i.e. if Relative Signal is much smaller than Absolute background.

As mentioned, IQ parameters may be optimized for different imaging modes each involving a different optimization model. In the following sections examples of optimization models for, Best throughput, Best image, 3D sectioning modes are schematically disclosed:

### Best Throughput Mode:

Keep exposure as short as possible
Increase laser power to max setting below saturation
High Sensitivity mode (High camera gain) is default, switch to High Dynamic range mode (Low camera gain) only for bright sample case
Line scanning mode (non-confocal Open Aperture mode) is default, switch to Line Confocal only if (1) SBR<0.3 and (Relative signal >500)

Best Image Mode:
Laser power is a preferred parameter to adjust since its increase helps to achieve highest throughput.
High Dynamic mode is a preferred since it allows to get images with best possible SNR. High Dynamic mode should be used unless sample is very dim and Absolute Signal cannot reach Best range at full laser power and max exposure.
Line scanning mode is a preferred mode. Line confocal mode shall be used only if SBR is <0.3—i.e. if Relative Signal is much smaller than Absolute background

3D Imaging Mode:
Line Confocal mode is default, use narrow initial confocal aperture setting (e.g. 1 AU)
Keep exposure as short as possible
Increase laser power to max setting below saturation
High Sensitivity mode is default, switch to High Dynamic range only for bright sample case

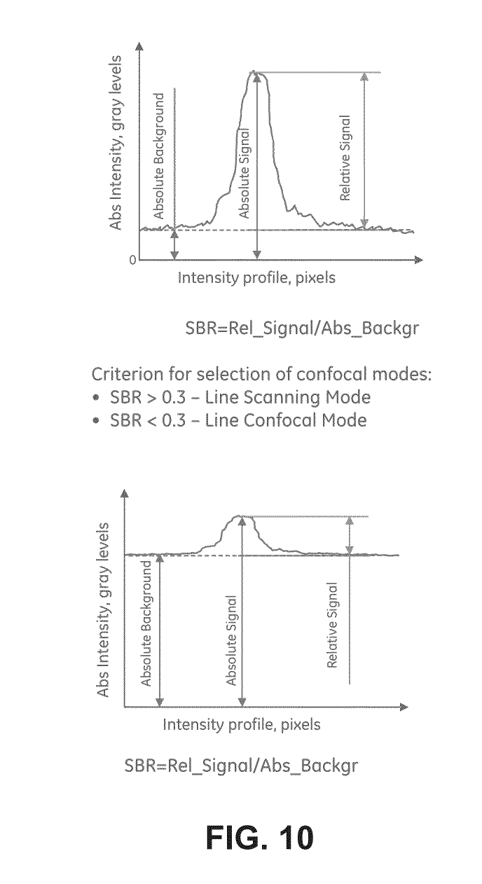

FIG. 10 illustrates graphically examples of selection criteria for a line confocal microscope system capable of being operated in Line Scanning (non-confocal or Open Aperture) and Line confocal modes.

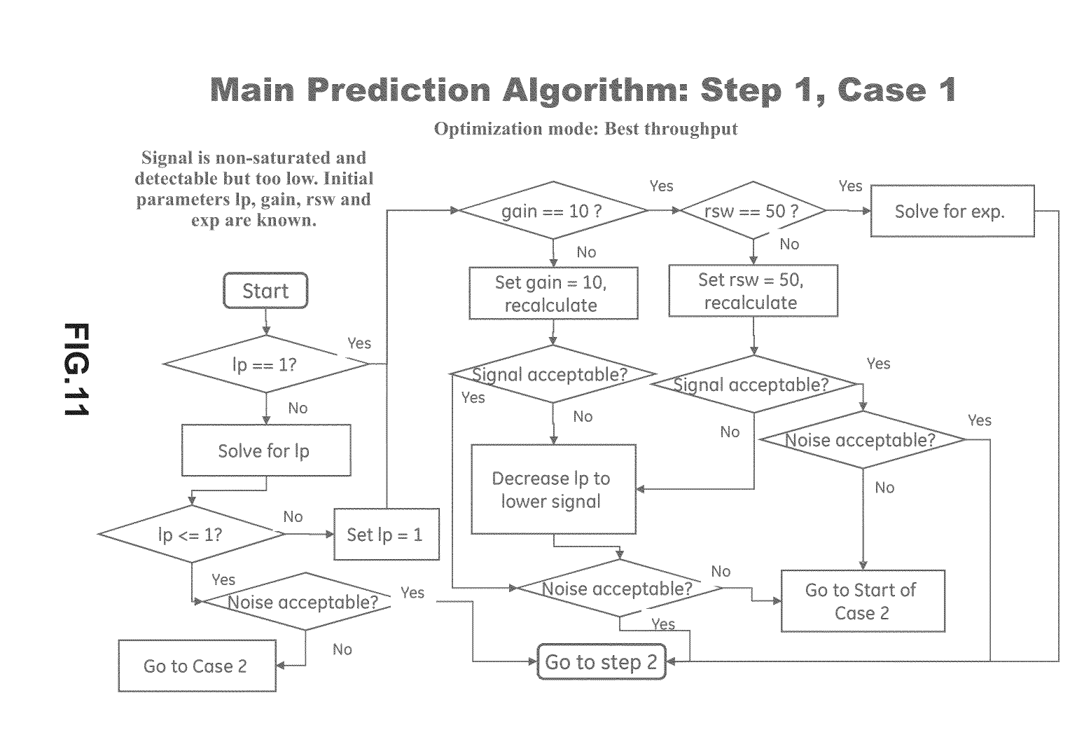

FIGS. 11-14 shows schematic flow charts for examples different cases involving the optimization model for best throughput wherein:

Prerequisites:

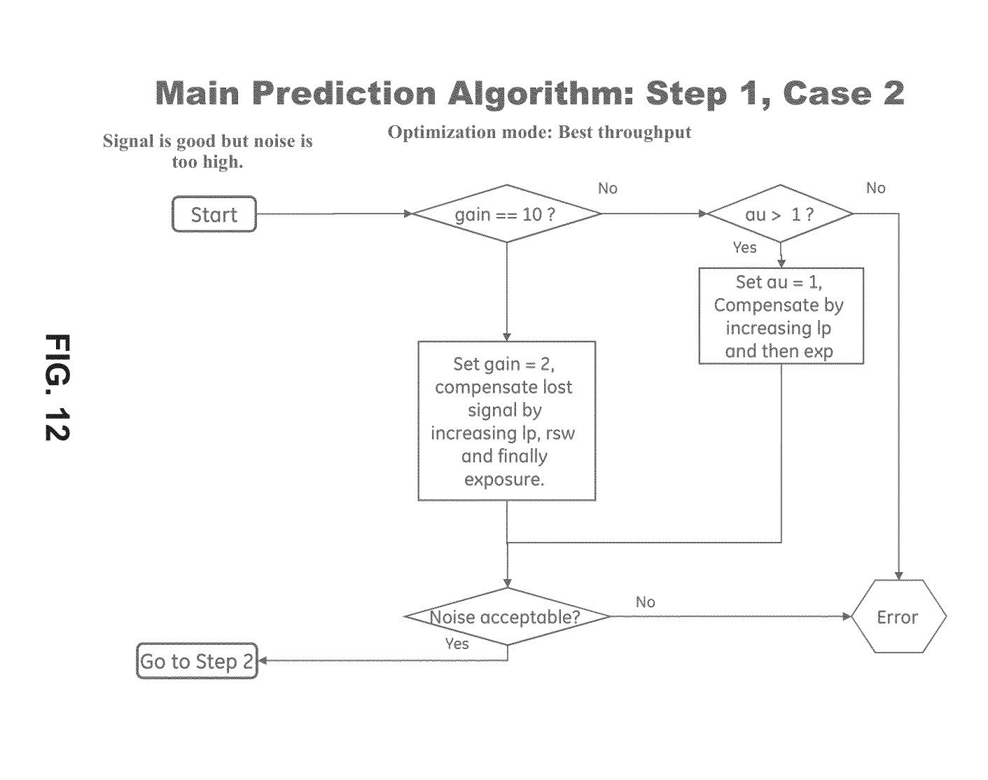

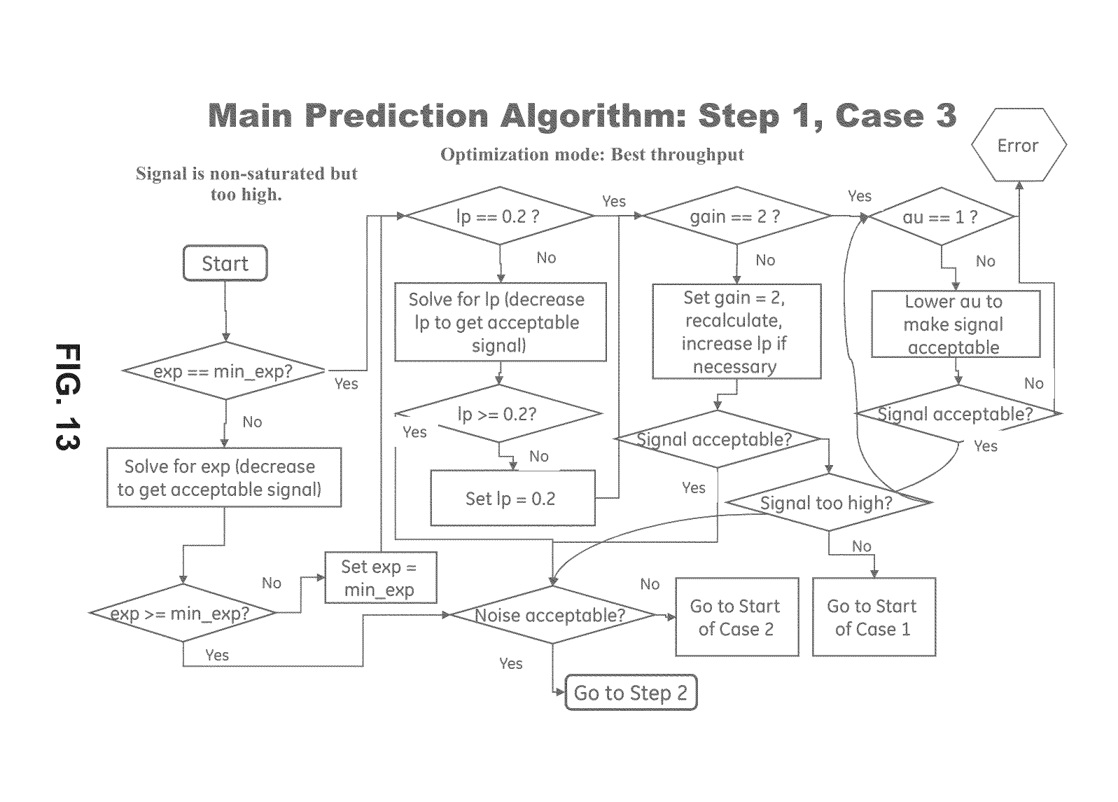

On entry, the signal is non-saturated but detectable.
The following cases are considered:
Case 1: Signal is non-saturated but too strong (near-saturation) (FIG. 11)
Case 2: Signal is acceptable but noise is too high (FIG. 12)
Case 3: Signal is detectable but too weak (FIG. 13)

These cases are considered separately in Step 1. After finishing Step 1, a set of parameters lp, gain, rsw, exp, is obtained. Such set of parameters will yield an image on which the signal and noise will be acceptable.

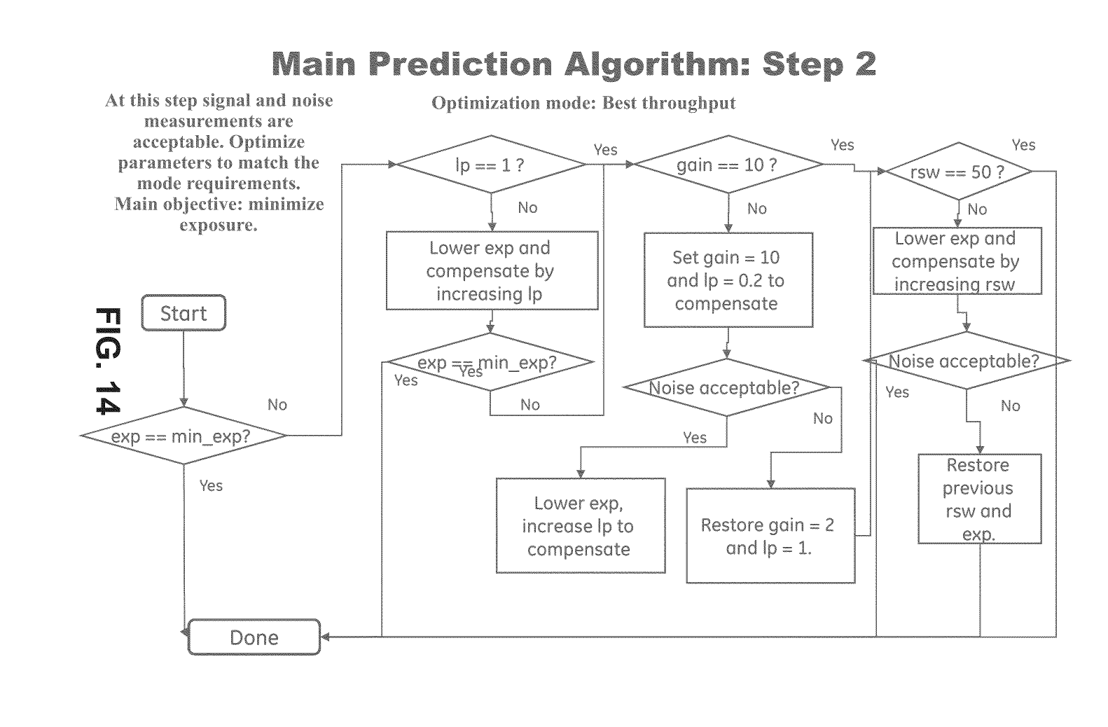

Step 2 (FIG. 14) aims at fine tuning the parameters calculated in Step 1 to meet the particular needs of the current optimization mode. In case of Best throughput, which we consider here, the main goal is to minimize the exposure time. The operations performed in step 2 are supposed to keep the signal and noise levels unchanged, or at least within the specified acceptance criteria.

Similar algorithm may be developed for other optimization modes. Other use cases may also be predicted, such as when the signal on entry is saturated or when the signal on entry is undetectable.

The presently preferred embodiments of the invention are described with reference to the drawings, where like components are identified with the same numerals. The descriptions of the preferred embodiments are exemplary and are not intended to limit the scope of the invention.

Although the present invention has been described above in terms of specific embodiments, many modification and variations of this invention can be made as will be obvious to those skilled in the art, without departing from its spirit and scope as set forth in the following claims.

1. A microscopy system for biological imaging, comprising an image quality optimizer for optimizing image quality of an image of a biological sample, allowing a user to select an optimization mode from a list of functionally defined optimization modes, and wherein the system is arranged to automatically set one or more image acquisition parameters to achieve optimal imaging for the selected optimization mode based on at least one image quality parameter derived from one or more Biological Reference Objects (BRO) in the image of the biological sample selected by the user or automatically by the system.

2. The microscopy system of claim 1, wherein the functionally defined optimization modes comprises one or more of:
Best image quality;
Fast acquisition;
Low bleaching; and
3D imaging.

3. The microscopy system of claim 1, wherein the image quality parameter is one or more of:
the Relative Signal between the BRO(s) and the background;
the Signal to Background Ratio (SBR) between the Relative Signal and the background; and
the Signal to Noise Ratio between the Relative Signal and the Background Noise.

4. The microscopy system of claim 1, comprising an image quality monitoring system for monitoring image quality of an image of a biological sample comprising:
a biological object selection means arranged to let a user of the system to select one or more Biological Reference Objects (BRO) in the image of the biological sample;
an image quality evaluation means arranged to compare the signal level of image pixels of the one or more BROs with an image background signal level to calculate one or more image quality parameters for the image of the biological sample; and
wherein the one or more image quality parameters are used by the quality optimizer for optimizing the image quality.

5. The microscopy system of claim 4, comprising a background selection means arranged to let a user of the system to select one or more Background Reference Regions (BRR) in the displayed image of the biological sample and wherein the system is arranged to use the signal level of image pixels of the one or more BRRs as the image background signal level for calculating the one or more image quality parameters.

6. The microscopy system of claim 4, being arranged to automatically select one or more Background Reference Regions (BRR) in the displayed image of the biological sample, and arranged to use the signal level of image pixels of the one or more BRRs as the image background signal level for calculating the one or more image quality parameters.

7. The microscopy system of claim 6, being arranged to select BRRs by locating the image pixels with the lowest signal level.

8. The microscopy system of claim 4, wherein the biological object selection means is arranged to let the user select the one or more BRO's by marking one or more Regions of Interest (ROI) in the displayed image of the biological sample.

9. The microscopy system of claim 4, wherein the system is arranged to automatically detect and select additional BROs and/or BRRs in the image or in subsequent images based on characterizing features of the BRO(s)/BRR(s) selected by the user, and use them for calculation of the image quality parameter(s).

10. The microscopy system of claim 4, wherein the system is arranged to automatically re-position BROs and/or BRRs in the image or in subsequent images based on lateral shift of the sample.

11. The microscopy system of claim 1, wherein it is a fluorescence microscope comprising an excitation light source, and a detector arranged to register fluorescence emitted from the biological sample.

12. The microscopy system of claim 11, wherein it is a confocal microscope, or a line confocal microscope with a variable confocal aperture.

13. A method for optimizing image quality of an image of a biological sample from a microscopy system for biological imaging,
selecting an optimization mode from a list of functionally defined optimization modes,
deriving at least one image quality parameter from one or more Biological Reference Objects (BRO) in the image of the biological sample selected by a user or automatically, and
setting one or more image acquisition parameters to achieve optimal imaging for the selected optimization mode based on an optimization model.
